(19) United States
(12) Patent Application Publication
(10) Pub. No.: US 2020/0208434 A1
(43) Pub. Date: Jul. 2, 2020

(54) KEY BOX

(71) Applicant: IHI TRANSPORT MACHINERY CO., LTD., Tokyo (JP)

(72) Inventor: Akira HATANO, Kanagawa (JP)

(21) Appl. No.: 16/617,295

(22) PCT Filed: May 11, 2018
(86) PCT No.: PCT/JP2018/018430

§ 371 Date: Feb. 7, 2020

(30) Foreign Application Priority Data
May 31, 2017 (JP) 2017-107291

(51) Int. Cl. E05B 19/00; E05F 15/616; E05B 47/00; G07C 9/00

(52) U.S. Cl. CPC E05B 19/0005; E05F 15/616; G07C 2009/0019; G07C 9/00182; E05B 47/0012

(57) ABSTRACT

The present invention intends to provide a key box that lends a key only to an authorized person without requiring external connection via a network. A key box 1 includes a lid 5 that rotates centered on a shaft 6 on a lower end side, in an opening part 4 that is on a front surface side of a housing 2 including a key storage space 3 therein. The housing 2 includes therein: a cord-like member 9 having a proximal end side 9a connected to the inside of the housing 2, and a distal end side 9b at which a key holder 10 for holding a key X is provided; a holding unit 7 that holds the lid 5 in a closed posture in which the opening part 4 is blocked; an opening operation unit 8 that releases the holding of the lid 5 by the holding unit 7 to open the lid 5; a signal communication section 11; a power source 12; and a controller 13. The housing 2 includes a startup switch 14. Once the startup switch 14 has been operated, and the signal communication section 11 has received a previously set authentication signal from an authentication unit carried by a user, the controller 13 gives an opening operation command to the opening operation unit 8 to open the lid 5, and enables takeout of the key X stored in the key storage space 3 to the outside through the opening part 4.

### TECHNICAL FIELD

The present invention relates to a key box that performs unmanned lending of a key.

### BACKGROUND ART

If there is no attendance of a manager at the time of a private viewing of a house for the purpose of, for example, rent and sale, processing of lending a key of a lock at an entrance of the house for a viewing (hereinafter, simply referred to as the house key) to the viewer, is required.

An arrangement of an attendant for such lending of the house key will incur personnel expenses. Thus, unmanned lending is desirable for lending of the house key.

Conventionally, for example, a lending/returning system of a joint-use item that utilizes a key box has been proposed as a device for automatically performing lending and returning of a key to a joint-use item (e.g., see Japanese Unexamined Patent Application Publication No. 2006-79199).

### SUMMARY OF INVENTION

### Technical Problem

However, in the system disclosed in Japanese Unexamined Patent Application Publication No. 2006-79199, the key box is required to have a function to perform communication with a reservation center via a network.

Accordingly, although the key box shown in Japanese Unexamined Patent Application Publication No. 2006-79199 can be applied to, for example, processing of automatically lending a key such as the house key, in that case, there is a need of installing a key box and of providing a network equipment for enabling the key box to communicate with the reservation center.

Thus, the present invention intends to provide a key box that can automatically lend a key to an authorized user without external connection via a network.

### Solution to Problem

An object of the present invention is to solve the problem described above and to provide a key box that includes: a housing having a key storage space therein, the housing including an opening part that communicates with outside in a front side of the key storage space, a lid that blocks the opening part, and a shaft that is disposed on a lower end side of the opening part to hold the lid in a rotatable manner in a front-rear direction; a holding unit that holds the lid in a closed posture in which the opening part is blocked; an opening operation units that releases the holding of the lid in the closed posture by the holding unit to open the lid; a cord-like member including one end connected to an inside of the housing, and another end provided with a key holder which holds a key, and that couples the housing and the key holder; a signal communication section; and a controller. The controller has a function to give an opening operation command for the opening operation unit to open the lid, based on an input of an authentication signal into the signal communication section.

The controller is connected to a power source, and the power source is a primary battery or a secondary battery disposed inside the housing.

The signal communication section is configured to receive the authentication signal via wireless communication.

The housing includes a startup switch, and the controller is configured to have a function to conduct a power saving mode that stops supplying power at least to the signal communication section during a time period in which the startup switch is not operated.

### Advantageous Effects of Invention

With the key box according to the present invention, lending of a key to an authorized user can be automatically performed without external connection via a network.

### BRIEF DESCRIPTION OF DRAWINGS

FIG. 1 is a schematic front view illustrating an embodiment of a key box.

FIG. 2 is a schematic front view illustrating the key box in FIG. 1 in a lid-opened state.

FIG. 3 is a schematic side view of the key box in FIG. 1.

FIG. 4 is a figure illustrating a housing body of an exemplary housing.

FIG. 5 is a figure illustrating inner surfaces of a cover and a lid of the housing.

FIG. 6(a) and FIG. 6(b) are cross-sectional side views of the key box in FIG. 1.

FIG. 7(a) and FIG. 7(b) are cross-sectional plan views of the key box in FIG. 1.

FIG. 8 is a figure illustrating an exemplary opening operation unit for the lid.

FIG. 9 is a schematic view illustrating a usage state of the key.

FIG. 10 is a figure for explaining a function of a controller.

### DESCRIPTION OF EMBODIMENTS

Embodiments of a key box according to the present invention will now be described with reference to the attached drawings.

### Embodiments

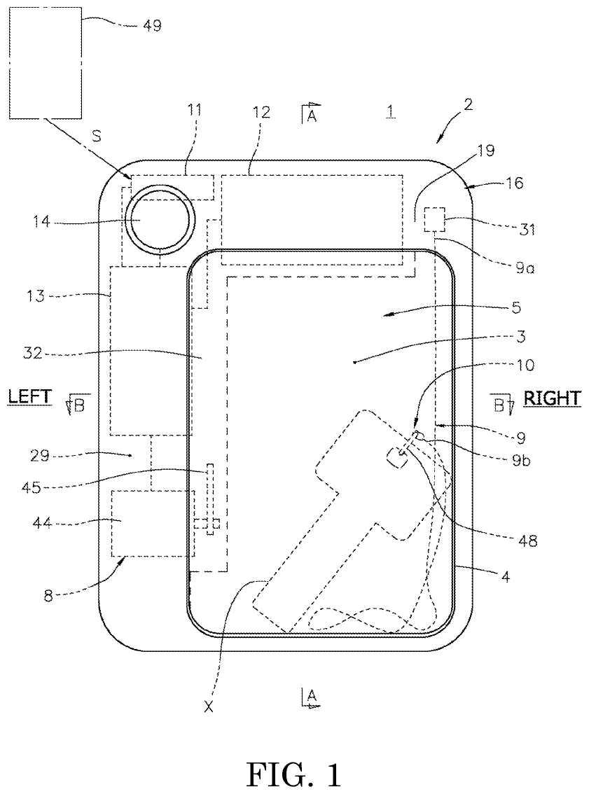

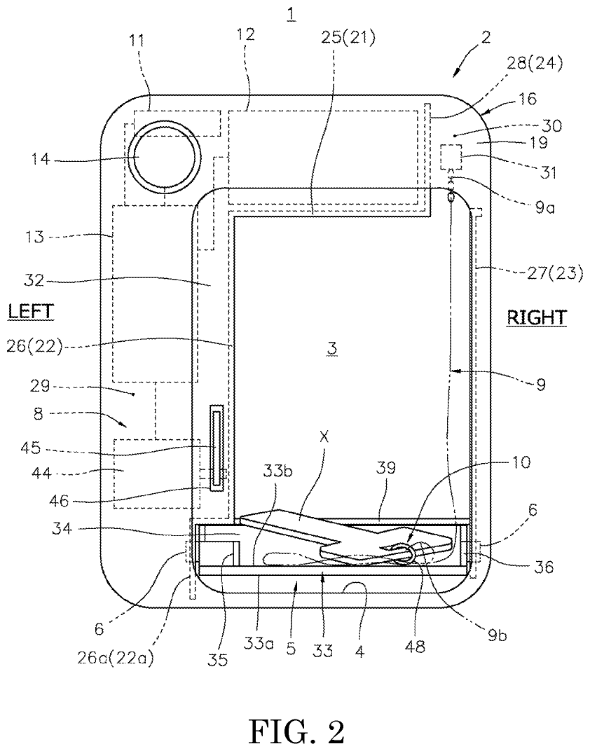

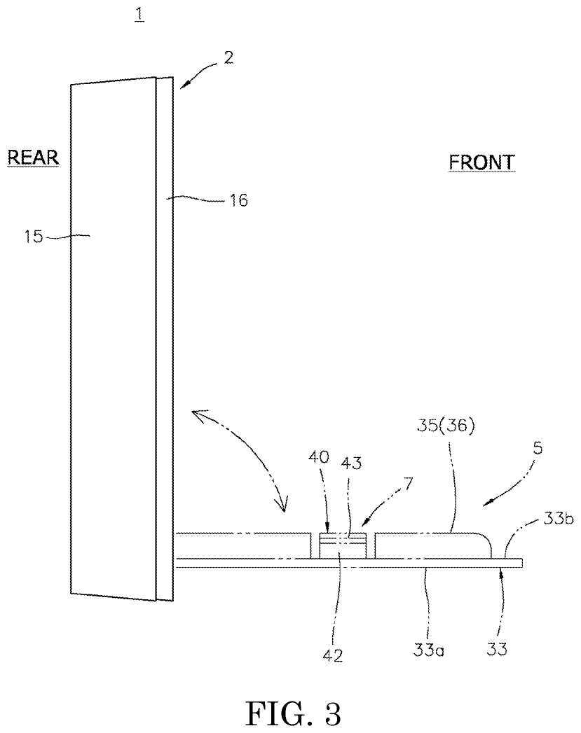

FIG. 1 is a schematic front view illustrating an embodiment of a key box. FIG. 2 is a schematic front view of the key box in FIG. 1 in a lid-opened state. FIG. 3 is a schematic side view of the key box.

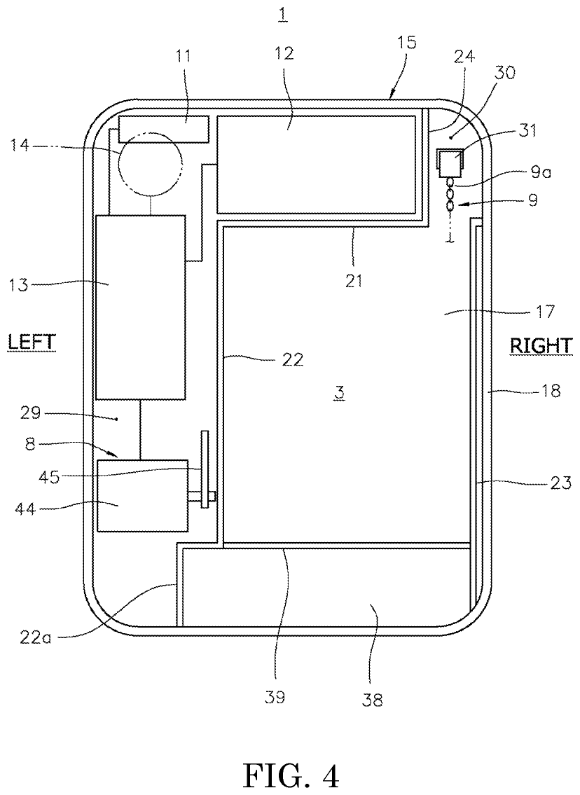

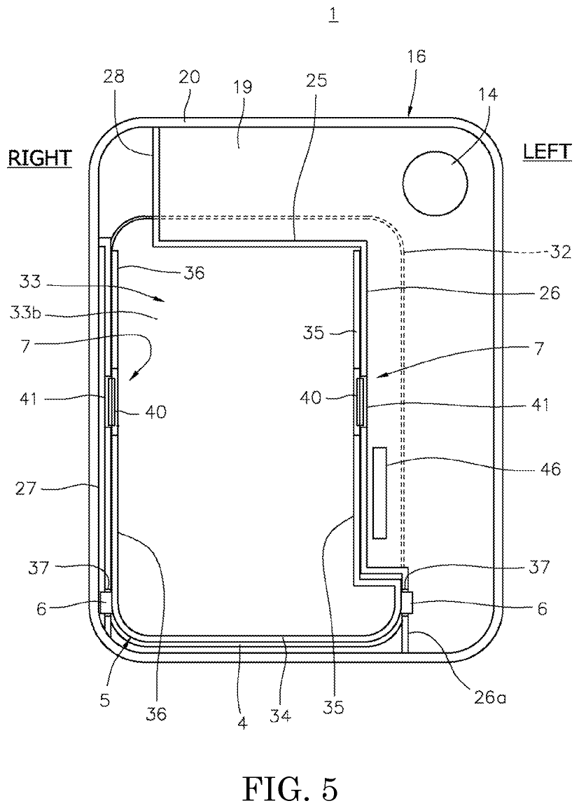

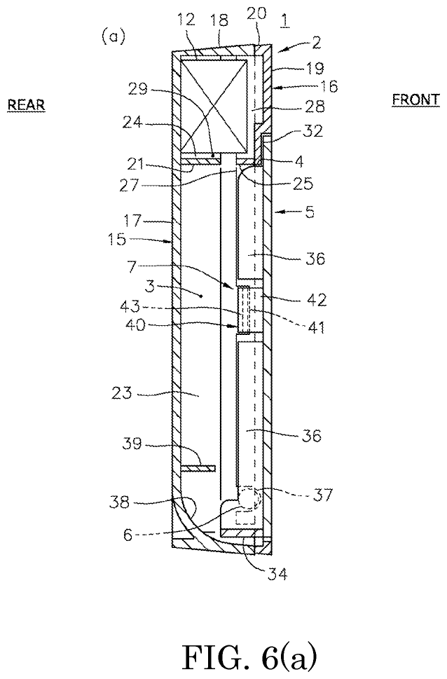

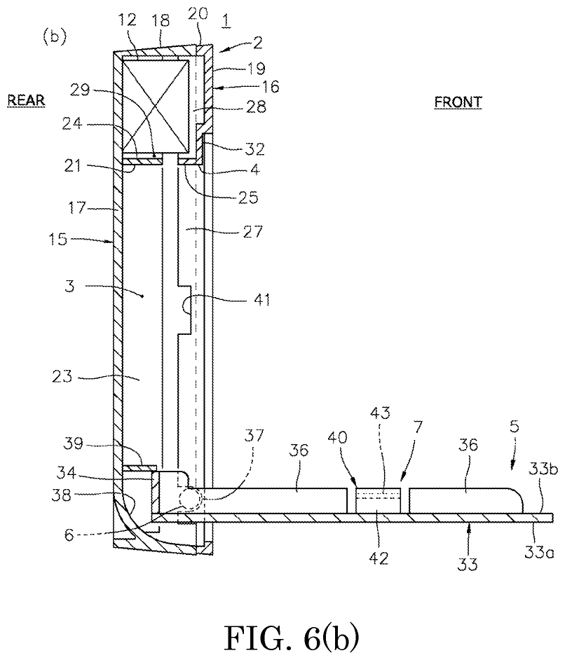

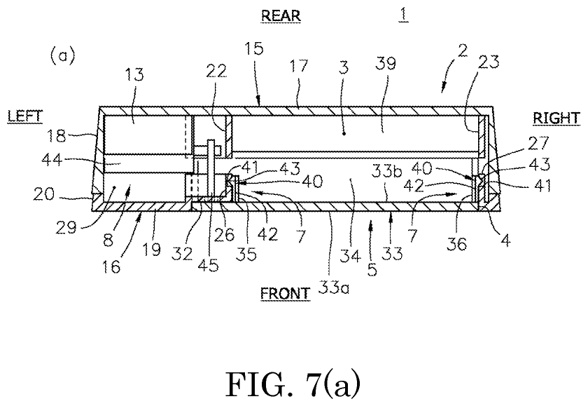

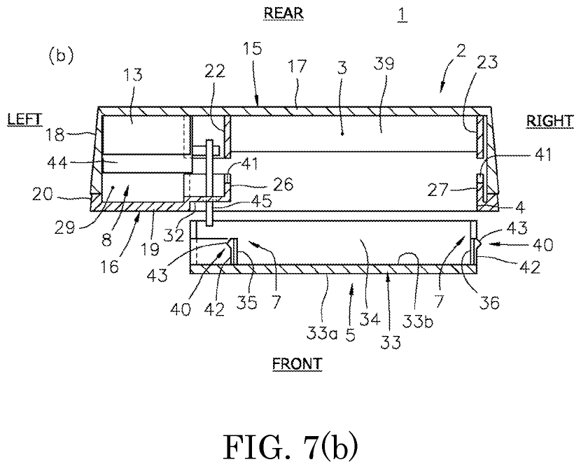

FIG. 4 is a schematic front view illustrating a housing body in an exemplary housing of the key box, and FIG. 5 is a schematic view of a cover and a lid in the housing that are seen from the rear. FIG. 6(a) and FIG. 6(b) are schematic cross-sectional side views of the key box. FIG. 6(a) is a schematic cross-sectional side view taken along line A-A in FIG. 1, and FIG. 6(b) is a schematic cross-sectional side view of the key box in the lid-opened state in FIG. 2 taken along the line A-A in FIG. 1. FIG. 7 (a) and FIG. 7(b) are schematic cross-sectional plan views of the key box in FIG. 1. FIG. 7(a) is a schematic cross-sectional plan view taken along line B-B in FIG. 1, and FIG. 7(b) is a schematic cross-sectional plan view taken along line B-B in FIG. 1, which illustrates a state of a holding unit in which locking of the lid is released.

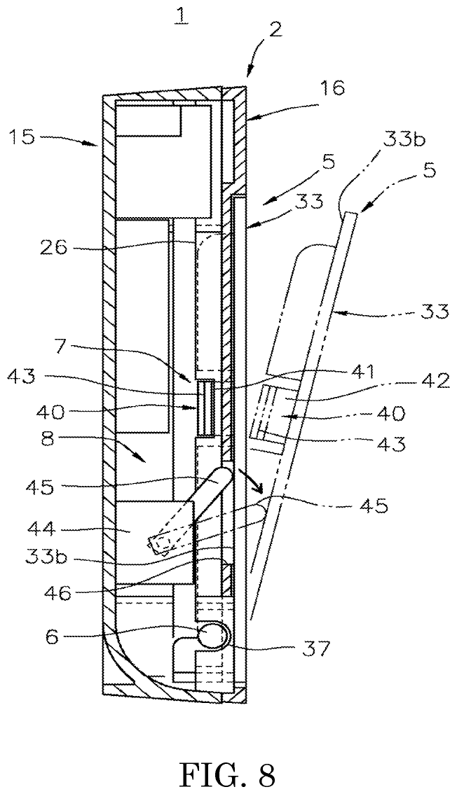

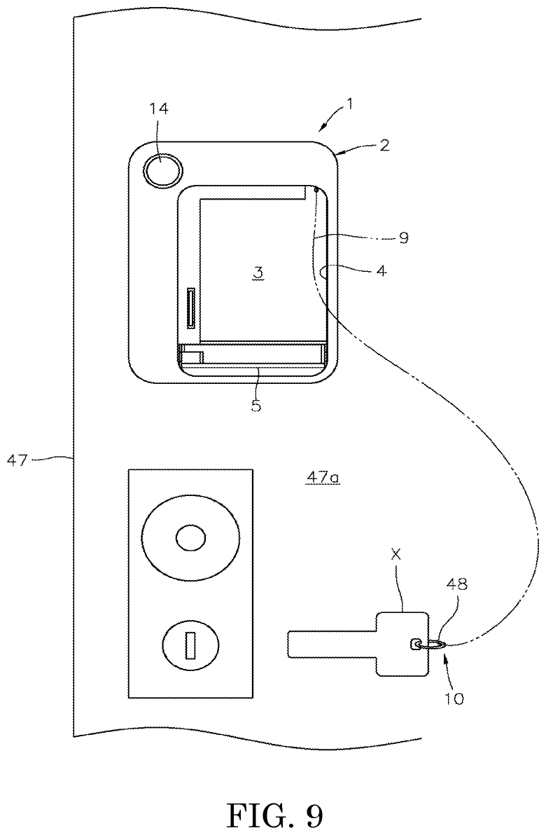

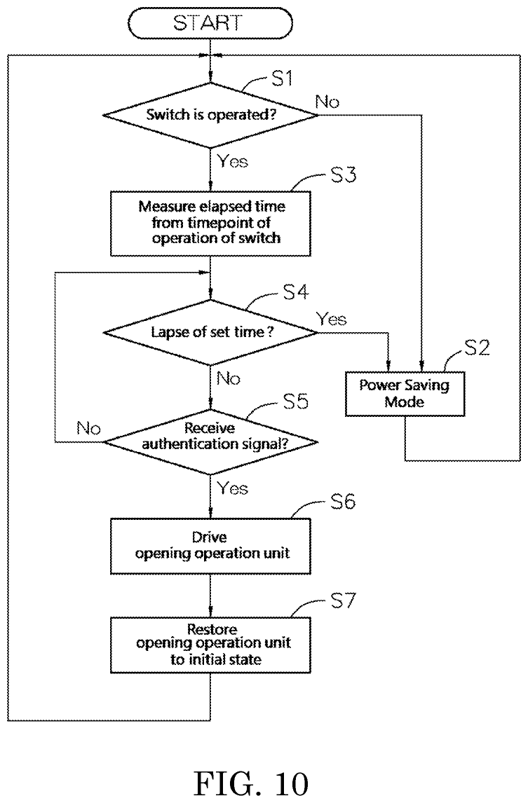

FIG. 8 is a schematic view of an opening operation unit of the lid that is seen from a left side. FIG. 9 is a schematic view illustrating a usage state of a key that is taken out from the key box. FIG. 10 is a flow chart illustrating processing by a controller.

Reference sign 1 in FIG. 1, FIG. 2, and FIG. 3 denotes the key box according to the present embodiment. For convenience of explanation, the front side in FIG. 1 and FIG. 2, and the right side in FIG. 3 will be referred to as a front side of the key box 1, and the rear side in FIG. 1 and FIG. 2, and the left side in FIG. 3 will be referred to as a rear side of the key box 1. Further, a left-right direction in FIG. 1 and FIG. 2 will be regarded as a left-right direction of the key box 1. In addition, for convenience in illustrating the configuration of the key box 1 according to the present embodiment, illustrations of a key X, a cord-like member 9 and a key holder 10 stored in the key box 1 according to the present embodiment will be omitted in FIG. 4 to FIG. 7(a) and FIG. 7(b). The cord-like member 9 and the key holder 10 will be described below.

The key box 1 according to the present embodiment includes a housing 2 having a key storage space 3 that can store the key X therein. The housing 2 includes an opening part 4 that communicates with outside in a front side of the key storage space 3, and a lid 5 that blocks the opening part 4. The lid 5 is configured to rotate in a front-rear direction centered on shaft 6 that is disposed on a lower end side of the opening part 4. Further, the key box 1 according to the present embodiment includes a holding unit 7 that holds the lid 5 in a closed posture in which the opening part 4 is blocked, and an opening operation unit 8 that releases the holding of the lid 5 in the closed posture by the holding unit 7 to open the lid 5. In addition, the key box 1 includes the cord-like member 9, which can be stored in the key storage space 3, having a proximal end side 9a as one end side connected to an inside of the housing 2, and the key holder 10, which is attached to a distal end side 9b as another end side of the cord-like member 9. Moreover, the key box 1 includes a signal communication section 11, a power source 12, a controller 13, and a startup switch 14.

The housing 2 has a flat, substantially cuboid shape, and a front-rear directional dimension thereof is smaller than an up-down directional dimension and a left-right directional dimension thereof.

The housing 2 includes, for example, a housing body 15, a cover 16 that is attached to a front surface side of the housing body 15, and the lid 5.

As illustrated in FIG. 4, FIG. 6(a), FIG. 6(b), FIG. 7(a), and FIG. 7(b), the housing body 15 is in a box form having an opened front surface, by including a rear sidewall 17 in a rectangle shape having four rounded corners, and a peripheral wall 18 in a substantially square tube shape that extends to a front in a set dimension from a peripheral edge of the rear sidewall 17.

Further, the housing body 15 includes an attaching unit (not illustrated) for attaching the rear surface side of the rear sidewall 17 to a wall surface or a door surface of a housing such as a detached house or a multiple dwelling house. Needless to say, for example, an adhesive pad, a magnet for causing magnetic attachment to a door or wall made of steel, a fixation means by using a screw or bolt, an adhesive agent, or any other attaching means may be employed as the attaching means, in accordance with characteristics of a place to which the key box 1 according to the present embodiment is desired to be attached, or the intended use of the key box 1 according to the present embodiment such as temporal installation or permanent installation.

As illustrated in FIG. 5, FIG. 6(a), FIG. 6(b), FIG. 7(a), and FIG. 7(b), the cover 16 includes a front sidewall 19 in a rectangle shape having four rounded corners, and a frame 20 in a substantially square tube shape that projects for, for example, several millimeters to the rear from the peripheral edge of the front sidewall 19. The cover 16 is attached to the front surface side of the housing body 15 in a state which a projecting end part of the frame 20 abuts against a projecting end part of the peripheral wall 18 of the housing body 15.

As illustrated in FIG. 1, FIG. 2, and FIG. 4, the key storage space 3 is provided inside the housing 2 in an arrangement that is, for example, close to the bottom right as seen from the front.

As illustrated in FIG. 4, FIG. 6(a), FIG. 6(b), FIG. 7(a), and FIG. 7(b), partition walls 21, 22 and 23, each of which projects to the front by a set projection amount, for example, a projection amount that is about the half of that of the peripheral wall 18, are provided at positions along the upper end side, left end side, and right end side of the key storage space 3 on the inner surface (front surface) of the rear sidewall 17 of the housing body 15.

Further, a bent part 22a that is bent in a crank shape in a direction that increases the width dimension of the key storage space 3 is provided on the lower end side of the partition wall 22 on the left side.

With regard to the partition wall 21 on the upper side, while a left end side of the partition wall 21 is connected to an upper end part of the partition wall 22 on the left side, a right end side of the partition wall 21 only extends to a position that is separated from the partition wall 23 on the right side with a gap of a set size. A partition wall 24 that projects from the inner surface (front surface) of the rear sidewall 17 by the above-described set projection amount is provided between the right end part of the partition wall 21 on the upper side and an upper position of the peripheral wall 18 that is positioned above the partition wall 21 in an arrangement extending in the up-down direction.

As illustrated in FIG. 2, FIG. 5, FIG. 6(a), FIG. 6(b), FIG. 7(a), and FIG. 7(b), on the inner surface (rear surface) of the front wall 19 of the cover 16, a partition wall 25, a partition wall 26 and a bent part 26a thereof, and a partition wall 27 are provided to project to the rear, at positions along the upper end side and the right and left sides of the key storage space 3, i.e., positions opposing the partition wall 21, the partition wall 22 and the bent part 22a thereof, and the partition wall 23 of the housing body 15. Further, a partition wall 28 is provided to project to the rear, at a position corresponding to the partition wall 24 of the housing body 15.

The projecting end parts of the partition wall 21, the partition wall 22, the bent part 22a, the partition wall 23, and the partition wall 24 in the housing body 15 oppose to the projecting end parts of the partition wall 25, the partition wall 26, the bent part 26a, the partition wall 27, and the partition wall 28 in the cover 16, respectively. The respective opposing projecting end parts are closely disposed with a gap therebetween of a size that does not allow passing of the key X or the cord-like member 9. Alternatively, the opposing projecting end parts of the partition wall 21 and the partition wall 25, the partition wall 22 and the partition wall 26, the bent part 22a and the bent part 26a, the partition wall 23 and the partition wall 27, and the partition wall 24 and the partition wall 28 may mutually contact.

In this manner, as illustrated in FIG. 2, in the inside of the housing 2, the key storage space 3 is formed in the state in which the upper side and the right and left sides of the key storage space 3 are surrounded by the partition walls 21 and 25, the partition walls 22 and 26 and the bent parts 22a and 26a thereof, and the partition walls 23 and 27.

In addition, in the inside of the housing 2, a compartment 30 that communicates with the upper end side of the key storage space 3 is provided at a position on the right side from the partition walls 24 and 28. A front side of the compartment 30 is covered with the cover 16, and this compartment 30 is provided with a connection part 31 for connection with the proximal end side 9a of the cord-like member 9.

Further, in the inside of the housing 2, an equipment storage space 29 is formed, in an arrangement from the upper side to the left side of the key storage space 3, by being partitioned from the key storage space 3 and the compartment 30 with the partition walls 21 and 25, the partition walls 22 and 26 and the bent parts 22a and 26a thereof, and the partition walls 24 and 28.

On the front wall 19 of the cover 16, the opening part 4 is provided to penetrate in the front-rear direction, at a position that is the front of the key storage space 3, i.e., a part where three directions, the upper side and the right and left sides thereof, are surrounded by the partition wall 25, the partition wall 26 and the bent part 26a thereof, and the partition wall 27.

Further, on the front wall 19, a depression 32 depressed toward the rear is provided from a position above the bent part 26a of the partition wall 26 to a position above the key storage space 3, in an arrangement partially overlapping with the equipment storage space 29 in the front-rear direction. The depression dimension of the depression 32 from a front end part of the front wall 19 is a dimension that corresponds to a thickness of a lid body 33 of the lid 5. The lid body 33 will be described below.

According to the present embodiment, a shape consisting of this depression 32 and the opening part 4 as seen from the front is set to have a rectangle shape with four rounded corners.

As illustrated in FIG. 1 and FIG. 5, the lid 5 includes the plate-like lid body 33 having a rectangle shape with four rounded corners that corresponds to the shape consisting of the depression 32 and the opening part 4. Accordingly, the lid body 33 can dispose a part near the upper end and the left end of the lid body 33 to abut against the front surface of the depression 32 of the cover 16, while blocking the opening part 4 of the cover 16.

In this regard, for convenience of explanation, as illustrated in FIG. 1, FIG. 5, FIG. 6(a), and FIG. 7(a), a surface of the lid body 33 directed to the front in the closed posture in which the opening part 4 is blocked, is referred to as a front surface 33a, and a surface directed to the rear is referred to as a rear surface 33b.

As illustrated in FIG. 5, FIG. 6(a), FIG. 6(b), FIG. 7(a), and FIG. 7(b), on the rear surface 33b of the lid body 33, a frame part 34 that projects in a set dimension from the rear surface 33b is provided along an edge part that becomes the lower end side in the closed posture.

In addition, on the rear surface 33b of the lid body 33, a frame part 35 on the left side is provided to project in a set dimension from the rear surface 33b, in an arrangement along a surface facing the inner side of the opening part 4 in the partition wall 26 and the bent part 26a thereof on the left side of the cover 16.

Further, on the rear surface 33b of the lid body 33, a frame part 36 on the right side is provided to project in a set dimension from the rear surface 33b, at a position along the surface facing the inner side of the opening part 4 in the partition wall 27 on the right side of the cover 16, i.e., a position along the edge part on the right side of the lid body 33.

A left end part of the frame part 34 is connected to the frame part 35 on the left side. Similarly, a right end part of the frame part 34 is connected to the frame part 36 on the right side. It should be noted that the frame part 34 and each of the frame parts 35 and 36 on the right and left are not necessarily be connected to each other. However, in that case, a gap between the frame part 34 and each of the frame parts 35 and 36 on the right and left is sized so as not to allow passing of the key X or the cord-like member 9.

Further, each of the frame parts 35 and 36 on the right and left is provided with the shaft 6, which extends in the left-right direction, on the lateral surface at a position that is near the lower end when the lid body 33 is in the closed posture.

Each shaft 6 is rotatably held by a bearing part 37 that is provided at positions corresponding to the bent part 26a of the partition wall 26 on the left side of the cover 16, and to the partition wall 27 on the right side of the cover 16.

According to the present embodiment, each bearing part 37 is provided for each of the bent part 26a of the partition wall 26 and the partition wall 27, as a groove-shaped notch that extends from the projecting end part in a direction approaching the lid body 33. According to this configuration, each bearing part 37 is easily formed.

In this manner, the lid 5 is freely rotatable in the front-rear direction (up-down direction) centered on the shaft 6, between the closed posture in which the opening part 4 is blocked by the lid body 33 as illustrated in FIG. 1 and FIG. 6(a), and a posture in which the lid body 33 projects approximately horizontally in the front of the housing 2 to open the opening part 4, as illustrated in FIG. 2 and FIG. 6(b).

Each of the frame parts 34, 35 and 36 is in an angle posture projecting to the rear from the rear surface 33b of the lid body 33, when the lid body 33 is in the closed posture. When the lid 5 rotates forward from the closed posture, each of the frame parts 34, 35 and 36 is in a posture projecting obliquely upward or upward from the rear surface 33b of the lid body 33. Thus, at the time of performing an opening/closing operation on the lid 5, the key X and the cord-like member 9 are prevented from exceeding each of the frame parts 34, 35, 36. Therefore, each of the frame parts 34, 35 and 36 can hold the key X on the rear surface 33b side of the lid body 33.

As illustrated in FIG. 6(a) and FIG. 6(b), the lower end side of the rear sidewall 17 of the housing body 15 is provided with a curved surface 38 in which the position of the front surface is displaced to the front as approaching the lower side. This curved surface 38 is formed such that a gap between the curved surface 38 and an arc-like movement track of the projecting end part of the frame part 34 in accordance with a rotation of the lid 5 in the front-rear direction, is sized so as not to allow passing of the key X or the cord-like member 9. In this manner, the key box 1 according to the present embodiment can prevent the key X and the cord-like member 9 from being caught in the gap between the rear sidewall 17 of the housing body 15 and the frame part 34 of the lid 5, at the time of a rotation of the lid 5 in the front-rear direction.

The housing body 15 is provided with a stopper 39 that projects to the front in a set dimension at a position that is the upper side of the curved surface 38 in the rear sidewall 17. As illustrated in FIG. 6(b), the position and the projecting dimension of the stopper 39 are set such that the projecting end part of the frame part 34 abuts against the undersurface of the stopper 39 on the projecting end side, when the lid 5 projects approximately horizontally to the front side of the housing 2 to be in a posture in which the opening part 4 is opened. In this manner, the key box 1 according to the present embodiment can open the opening part 4 by rotating the lid 5 forward to the position where the projecting end part of the frame part 34 abuts against the stopper 39. Further, the key box 1 according to the present embodiment can hold the lid 5 in the posture that opens the opening part 4, while the lid 5 is not rotated backward due to an external force.

As illustrated in FIG. 6(a), FIG. 6(b), FIG. 7(a), and FIG. 7(b), for example, the holding unit 7 includes a locking claw 40 provided on the lid 5, and a locking part 41 provided on the cover 16 to lock the locking claw 40.

According to the present embodiment, the lid 5 has a configuration in which, for example, each of the frame parts 35 and 36 on the right and left has a cutout in a set length dimension at a part thereof in the longitudinal direction (e.g., a longitudinal intermediate part thereof). The locking claw 40 is provided as a pair of left and right, at the places where each of the above-described cutouts of the frame parts 35 and 36 on the right and left is positioned on the rear surface 33b of the lid body 33.

The locking claw 40 includes a plate part 42 of a plate-spring type projecting from the rear surface 33b of the lid body 33 in the same dimension as that of the respective frame parts 35 and 36 on the right and left, that is elastically deformable and bends in the left-right direction, and a protrusion 43 provided in a protruding manner on a surface that is the external side in the left-right direction on the distal end side of the plate part 42.

The locking claw 40 is provided such that the plate part 42 is disposed at a position along the surface facing the inner side of the opening part 4 in the partition walls 26 and 27 on the right and left of the cover 16, and the protrusion 43 is disposed to interfere with each of the partition walls 26 and 27. As illustrated in FIG. 7(a) and FIG. 7(b), the protrusion 43 is in a mountain shape with inclined surfaces on both ends in a moving direction of the protrusion 43 in accordance with a rotation of the lid 5. In this manner, with regard to the locking claw 40, when the inclined surfaces of the protrusion 43 contact with the corresponding partition walls 26 and 27 at the time of the rotation of the lid 5, the plate part 42 bends, and the protrusion 43 is guided to the position along the surface facing the inner side of the opening part 4 of the corresponding partition walls 26 and 27.

Each of the partition walls 26 and 27 is provided with the locking part 41 which each protrusion 43 is fit into, at the position where each protrusion 43 of each locking claw 40 is disposed when the lid 5 is in the closed posture in which the opening part 4 is blocked. In order to facilitate the formation of each locking part 41, the locking part 41 is preferably formed as a notch from the projecting end part of each of the partition walls 26 and 27. However, needless to say, the locking part 41 may also be provided as an opening that penetrates in the left-right direction or a depression at an intermediate part in the front-rear direction of each of the partition walls 26 and 27.

As illustrated in FIG. 7(a), in the holding unit 7 configured as described above, the protrusion 43 of each locking claw 40 is locked by being fit into the corresponding locking part 41 when the lid 5 is arranged in the closed posture in which the opening part 4 is blocked. Thus, the key box 1 according to the present embodiment can hold the lid 5 in the closed posture by the holding unit 7, when the lid 5 is not rotated forward by the opening operation unit 8.

In addition, in the holding unit 7, when the lid 5 is rotated forward from the closed posture by the opening operation unit 8, the plate part 42 of each locking claw 40 bends, and the protrusion 43 is removed from the locking part 41 to be guided to the position along the surface facing the inner side of the opening part 4 of the corresponding partition walls 26 and 27. As illustrated in FIG. 7(b), when the lid 5 further rotates forward, and the protrusion 43 passes the corresponding partition walls 26 and 27, the lid 5 is automatically rotated forward due to its own weight and the weights of the key X and the cord-like member 9 applied on the rear surface 33b side of the lid body 33.

As illustrated in FIG. 2, FIG. 7(a), FIG. 7(b), and FIG. 8, for example, the opening operation unit 8 is configured to include a servo motor 44 that is laterally installed toward the opening part 4 at a position that is a side part of the opening part 4 in the equipment storage space 29, and a lever 45 with one end in the longitudinal direction that is the proximal end side attached to its output shaft.

Further, with regard to the lever 45, the other end in the longitudinal direction that is the distal end side is positioned on the inner side of a slit-shaped opening 46 provided in the depression 32 of the cover 16 to penetrate in the front-rear direction. In this manner, the opening operation unit 8 enables the distal end side of the lever 45 to project to the front side of the cover 16 as illustrated with a solid line in FIG. 7(b) or with a two-dot chain line in FIG. 8.

As illustrated in FIG. 8, the opening operation unit 8 positions the distal end side of the lever 45 to contact with the rear surface 33b of the lid body 33 through the opening 46, when the lid 5 is in the closed posture in which the opening part 4 is blocked. In the following descriptions, this state will be referred to as an initial state of the opening operation unit 8.

The opening operation unit 8 can forcibly rotate the lid 5 forward by driving the servo motor 44 from the initial state, and rotating the lever 45 forward, thereby pushing the lid body 33 forward on the distal end side of the lever 45. The opening operation unit 8 conducts the rotation of the lever 45 with the driving of the servo motor 44 until the protrusion 43 of each locking claw 40 of the lid 5 moves to the front of each of the partition walls 26 and 27.

In this manner, the opening operation unit 8 can release the holding of the closed posture of the lid 5 by the holding unit 7. As a result, the lid 5 with the holding having been released rotates forward due to its own weight and the weights of the key X and the cord-like member 9 held on the rear surface 33b side of the lid body 33. That is, the opening operation unit 8 can open the lid 5 to achieve a state in which the opening part 4 is opened.

It should be noted that the opening operation unit 8 may have a function that can remove the protrusion 43 of each locking claw 40 of the lid 5 from each locking part 41 by driving the servo motor 44 and pushing the lid body 33 forward with the rotation of the lever 45, and can rotate the lid 5 forward until a state in which a gap is formed between the lid 5 and the cover 16 is reached. Accordingly, the opening operation on the lid 5 by the opening operation unit 8 may be performed until the protrusion 43 of each locking claw 40 moves to the front of each of the partition walls 26 and 27 as described above, or until a state in which the protrusion 43 of each locking claw 40 contacts with each of the partition walls 26 and 27 is reached. In this manner, when the protrusion 43 of each locking claw 40 contacts with each of the partition walls 26 and 27, the lid 5 stops rotating forward in the position where the gap is formed between the lid 5 and the cover 16. In this case, the lid 5 can be manually and easily rotated forward, thereby reaching a state in which the opening part 4 is opened.

The opening operation unit 8 performs control to automatically restore the lever 45 in the initial state by driving the servo motor 44 in the backward direction, when a set time (e.g., several seconds) has passed after opening the lid 5 by rotating the lever 45 forward with the servo motor 44.

As illustrated in FIG. 9, the cord-like member 9 is sized to be longer than a distance from a place where the key box 1 according to the present embodiment is installed to a position of the lock at an entrance 47 of, for example, a house for which the key X is to be used. Further, the cord-like member 9 has a flexibility that allows folding of the cord-like member 9 to be stored in the key storage space 3. The cord-like member 9 may have strength and durability to an extent where any wear or cut does not easily occur even if folding and lengthening are repeatedly conducted. For example, a chain, a wire made of metal or resin, or a fiber rope is preferably used as the cord-like member 9. However, the cord-like member 9 made of other materials or made with other structures may also be used.

As illustrated in FIG. 2, with regard to the cord-like member 9, the proximal end side 9a is connected to the connection part 31 which is provided inside the compartment 30 formed on the upper side of the key storage space 3 in the inside of the housing 2. The reason why the proximal end side 9a of the cord-like member 9 is connected to the inside of the compartment 30 in such manner will now be described.

That is, for example, if the proximal end side 9a of the cord-like member 9 is connected to the housing 2 in the inside of the key storage space 3, at the time of use or storing of the key X, force may act in various directions of a combination of up, down, right, left, and front, on the portion of the housing 2 where the proximal end side 9a of the cord-like member 9 is attached. Thus, the portion where the proximal end side 9a of the cord-like member 9 is attached requires a structure endurable with force that may act from various directions.

In contrast, with the configuration in which the proximal end side 9a of the cord-like member 9 is connected to the inside of the compartment 30 as according to the present embodiment, a direction of force acting from the cord-like member 9 on the connection part 31 which the proximal end side 9a of the cord-like member 9 is connected to, is limited to the direction of a place where the compartment 30 communicates with the key storage space 3. Further, the front side of the compartment 30 is covered with the cover 16. Therefore, a component force acting in the front direction of the force acting from the cord-like member 9 on the connection part 31 is limited to a small amount. Thus, according to the present embodiment, the structure of the connection part to which the proximal end side 9a of the cord-like member 9 is connected can be simplified as compared to a structure endurable with force from various directions as described above.

The key holder 10 is configured to include a ring part 48 for attachment through a hole that is generally provided for the key X. In this manner, the key holder 10 is attached to the key X by passing the ring part 48 through the hole of the key X. In this state, the key X is coupled to the housing 2 through the key holder 10 and the cord-like member 9.

It should be noted that, when the cord-like member 9 is a chain, the key holder 10 may be configured to include only the ring part 48. However, needless to say, the key holder 10 may have a shape and a structure other than those illustrated in accordance with the cord-like member 9 to be used, as long as having a function to allow attachment of the key X to the distal end side 9b of the cord-like member 9.

As illustrated in FIG. 1, FIG. 2, and FIG. 4, the controller 13, the power source 12, and the signal communication section 11 are provided for the equipment storage space 29 of the housing 2, in addition to the opening operation unit 8.

In addition, as illustrated in FIG. 1, the startup switch 14 (e.g., a push-button type) is provided for the housing 2 at a position that is the front side of the equipment storage space 29 on the front surface of the front wall of the cover 16. Needless to say, a switch in any form other than the push-button type such as a toggle-type switch may be used as the startup switch 14, as long as it is an automatic reset switch.

The signal communication section 11, the power source 12, and the startup switch 14 are connected to the controller 13.

In addition to the controller 13, the power source 12 supplies power to the signal communication section 11 and the servo motor 44 of the opening operation unit 8 through the controller 13.

In order to enable an installation of the key box 1 according to the present embodiment in various places, a primary battery or secondary battery is preferably used for the power source 12. Needless to say, the key box 1 according to the present embodiment may be configured to use a fuel battery as the power source 12, or may be configured to connect to commercial power supply such as an AC power source through a power source cord (not illustrated), instead of using the power source 12 disposed inside the housing 2.

When using a primary battery or secondary battery as the power source 12, the key box 1 according to the present embodiment may be configured to include an opening part with a lid that can be opened/closed (not illustrated) somewhere in the housing 2, such that the power source 12 by the primary battery or the secondary battery is held on an inner side of this opening part through, for example, a battery box (not illustrated). According to such configuration, a battery can be replaced easily by opening the lid of the opening part. In addition, needless to say, a battery of the key box 1 according to the present embodiment may be replaced by disassembling the housing 2, such as removing the cover 16 from the housing body 15, rather than including the opening part with the lid.

The signal communication section 11 receives, from an authentication unit 49, as illustrated with a one dot chain line in FIG. 1, that is carried by a user (not illustrated) who wishes to borrow the key X, an authentication signal S for confirming that the user has a usage permission.

It should be noted that a mobile terminal carried by the user such as a smartphone, tablet, or mobile phone, that has a function to allow obtainment of the authentication signal S by execution of an application program and external connection via a network, is preferably used as the authentication unit 49. The operation method of the key box 1 according to the present embodiment using this authentication unit 49 will be described below as a usage example.

Delivery of the authentication signal S from the authentication unit 49 to the signal communication section 11 may be performed via, for example, wireless communication such as near field communication. In this case, both of the authentication unit 49 and the signal communication section 11 may only be configured to include a communication module for wireless communication.

The following describes a function to execute key lending processing provided for the controller 13, with reference to the flow chart in FIG. 10.

Once the use of the key box 1 according to the present embodiment has started, the controller 13 first determines whether the startup switch 14 has been operated based on an input from the startup switch 14 (Step S1).

When the startup switch 14 is determined to be not operated in the above-described step S1, the controller 13 proceeds to step S2 to conduct a power saving mode. In this power saving mode, the controller 13 reduces a power consumption by stopping power supply at least to the signal communication section 11. In addition, in the power saving mode, the controller 13 may reduce the power consumption by setting the number of clocks of a CPU incorporated in the controller 13 itself lower than the number of clocks for the normal operation.

Once the power saving mode according to the above-described step S2 has started, the controller 13 returns to step S1. Accordingly, while the startup switch 14 has not been operated, the controller 13 sequentially repeats the processing loop according to step S1 and step S2. Thus, the key box 1 according to the present embodiment becomes in the power saving mode, and the power consumption can be reduced.

On the other hand, when the startup switch 14 is operated in the key box 1 according to the present embodiment, and the startup switch 14 is determined to be operated in the above-described Step S1, the controller 13 utilizes a clock function provided in the controller 13 itself to start measuring an elapsed time from the time point when the startup switch 14 starts to be operated (step S3). At this time, if the power saving mode according to the above-described step S2 has been started, the controller 13 releases the power saving mode to supply power to the signal communication section 11. In addition, if the number of clocks of the CPU incorporated in the controller 13 itself has been decreased, processing of restoring the number of clocks for the normal operation is performed.

Then, the controller 13 proceeds to step S4 to determine whether the elapsed time from the time point when the startup switch 14 starts to be operated, has reached a set time. While the set time has been determined to be not reached, the controller 13 proceeds to Step S5. The set time in this case may be set in accordance with an estimated maximum time that is required for a user to pick up the authentication unit 49 such as a mobile terminal, and to perform processing of sending the authentication signal S. For example, the set time may be set in a range from several minutes to about 10 minutes.

In step S5, the controller 13 determines whether the authentication signal S has been received based on an input from the signal communication section 11.

When the authentication signal S is determined to be not received in the above-described step S5, the controller 13 returns to the above-described step S4, and repeatedly conducts the processing loop according to the above-described step S4 and step S5, until the elapsed time from the time point when the startup switch 14 starts to be operated is determined to reach the set time in step S4, or the authentication signal S is determined to be received in step S5.

If the elapsed time from the time point when the startup switch 14 starts to be operated is determined to reach the set time in step S4 while the controller 13 has repeatedly performed the processing loop according to the above-described step S4 and step S5, the controller 13 proceeds to the above-described step S2 to start the aforementioned power saving mode again.

In addition, if the authentication signal S is determined to be received at the time when the controller 13 proceeds to step S5, the controller 13 proceeds to step S6.

In step S6, the controller 13 gives, to the servo motor 44 of the opening operation unit 8, an opening operation command to drive the lever 45 to rotate from the state illustrated with the solid line to the state illustrated with the two-dot chain line in FIG. 8.

Once the servo motor 44 is driven in accordance with this opening operation command, the key box 1 according to the present embodiment releases the locking of the locking claw 40 of the lid with respect to the locking part 41 of the cover 16 as described above, and the lid 5 is rotated forward from the state illustrated with the solid line to the state illustrated with the two-dot chain line in FIG. 8. Thus, the key box 1 according to the present embodiment becomes a state in which the opening part 4 is released to the outside, since the lid 5 subsequently rotates further forward due to its own weight and the weights of the key X and the cord-like member 9 stored in the key storage space 3, as illustrated in FIG. 2 and FIG. 6(b).

In this state, the key X having been stored in the key storage space 3 is exposed to outside.

Once the key X is exposed in such manner, the user can hold the key X in the user's hand. Further, as illustrated in FIG. 9, the user can perform an unlocking operation or locking operation on the lock by moving the key X still being connected to the cord-like member 9, to the position of the lock for which the key X is intended to be used.

Once the user finishes using the key X, the user places the key X and the cord-like member 9 on the lid 5 in an opened posture in the key box 1 according to the present embodiment, and rotates the lid 5 backward from that state, thereby returning to the closed posture in which the opening part 4 is blocked. When the lid 5 is in the closed posture, the locking claw 40 is locked by the locking part 41, and thus the lid 5 is held in the closed posture thereafter. Therefore, since the opening part 4 is blocked with the lid 5 in the key box 1 according to the present embodiment, the key X stored in the key storage space 3 is unable to be taken out from the opening part 4.

After the controller 13 restores the opening operation unit 8 to the initial state as described above, the controller 13 returns to step S1, and starts the processing from the above-described step S1 again.

Accordingly, with the key box 1 according to the present embodiment, lending of the key X can be performed only to a user that is authenticated by sending the authentication signal S using the authentication unit 49.

In addition, in the key box 1 according to the present embodiment, once the authentication signal S is input to the signal communication section 11, the controller 13 performs processing of giving the opening operation command to the servo motor 44 of the opening operation unit 8. Accordingly, the controller 13 does not require information on a user who carries the authentication unit 49, or information such as when the user will use the key X.

Thus, the key box 1 according to the present embodiment does not require external connection via a network.

It should be noted that a time period or time when the key X is made available, such as when to allow sending of the authentication signal S from the authentication unit 49, may be managed by an application program on the authentication unit 49 side.

Accordingly, the key box 1 according to the present embodiment can be applied to processing of automatically lending various kinds of the key X. In this case, an equipment cost required for automatically lending the key X can be reduced, since network equipment for enabling the key box 1 according to the present embodiment to perform external communication is not required to be provided.

In addition, since the key X is coupled to the housing 2 through the key holder 10 and the cord-like member 9, the key box 1 according to the present embodiment can prevent occurrence of a problem such as a problem that a user forgets to return the key X and takes it home, or loses the key X.

In the key box 1 according to the present embodiment, the controller 13 is in a standby state until the authentication signal S is input to the signal communication section 11.

In addition, the key box 1 according to the present embodiment is configured to include only one servo motor 44 of the opening operation unit 8 as a driving part that consumes power. Further, in the key box 1 according to the present embodiment, power supply to the servo motor 44 is not required in the holding of the lid 5 in the closed posture, and in the holding of the lid 5 in the opened posture. Thus, a power consumption by the servo motor 44 can be reduced in the key box 1 according to the present embodiment.

The signal communication section 11 may only receive the authentication signal S from the authentication unit 49 via wireless communication. Further, the authentication signal S, which is received by the signal communication section 11 via wireless communication, can be converted into an electrical signal without requiring special processing such as an image analysis. Thus, a power consumption by the signal communication section 11 and the controller 13 can be reduced in the key box 1 according to the present embodiment.

In addition, the power consumption can be further reduced in the key box 1 according to the present embodiment, since the key box 1 according to the present embodiment is configured to include the startup switch 14, and the power saving mode that stops supplying power at least to the signal communication section 11 is conducted during a time period in which the startup switch 14 is not operated.

As described above, the key box 1 according to the present embodiment can reduce the power consumption. Therefore, when a primary battery is used as the power source 12 in the key box 1 according to the present embodiment, the frequency of replacing the battery can be decreased. In addition, when a secondary battery is used as the power source 12, the frequency of battery charge can be decreased.

### Usage Example of Embodiment

The following describes a case in which the house key X is lent to a user who privately views a house, as a usage example of the key box 1.

In this case, the key box 1 according to the present embodiment is installed near the lock of the entrance 47 of the house as illustrated in FIG. 9, such as on a door 47a.

The key holder 10 is connected to the house key X. It should be noted that, for convenience of illustration, the dimensions and the relative dimensional ratio of the key box 1 and the entrance 47 of the house in FIG. 9 do not reflect the actual dimensions and the relative dimensional ratio.

The user who wishes to temporarily use the key X for a private viewing of the house makes a reservation for a time period for which the private viewing is desired, using a mobile terminal that is the authentication unit 49 (see FIG. 1) to connect to a reservation server (not illustrated) via a network.

The reservation server determines whether the private viewing of the house is available in the desired time period, which the user applied for use. If the private viewing is available, the reservation server sends a usage permission associated with a use time period of the key X corresponding to the desired time period for the private viewing, to the authentication unit 49 of the user.

An application program is set to be executable in the authentication unit 49 in advance. The application program enables sending of the authentication signal S (see FIG. 1) only in the time period for which the usage permission is given, based on the usage permission given from the reservation server.

In this state, the user goes to the house for the private viewing in the time period for which the usage permission is given. The user operates the startup switch 14 to execute the predetermined application program with the authentication unit 49 in a state that the authentication unit 49 is disposed near the key box 1 according to the present embodiment. In this manner, the authentication signal S is sent from the authentication unit 49 via wireless communication.

Once the key box 1 according to the present embodiment receives this authentication signal S with the signal communication section 11, the opening operation unit 8 rotates the lever 45 in accordance with the opening operation command from the controller 13 as described above. Then, the locking of the locking claw 40 of the lid 5 with respect to the locking part 41 is released, and the lid 5 is rotated forward. As a result, the lid 5 is opened, and the key X is exposed to the outside.

In this state, as illustrated in FIG. 9, the user holds the key X in the user's hand, and moves the key X connected to the cord-like member 9 to the position of the lock of the entrance 47 to perform the unlocking operation.

In this manner, the user can open the entrance 47, and privately view the house.

Once the private viewing has finished, the user performs the locking operation on the entrance 47 using the key X, and then places the key X and the cord-like member 9 on the lid 5 in the key box 1 according to the present embodiment. After doing so, the user arranges the lid 5 in the closed posture in which the opening part 4 is blocked.

In this manner, when the lid 5 is in the closed posture, the locking claw 40 of the lid 5 is locked to the locking part 41 as described above. Thus, the key box 1 according to the present embodiment holds the lid 5 in the closed posture until the startup switch 14 is operated again and the authentication signal S is received from the authentication unit 49.

The predetermined application program in the authentication unit 49 does not send the authentication signal S at time points before and after the time period for which the usage permission of the key X is given. Thus, even the user who made the reservation for the private viewing cannot take out the key X from the key box 1 according to the present embodiment at time points other than the time period for which the usage permission of the key X is given.

In addition, since people who have not made a reservation for the private viewing cannot take out the key X from the key box 1 according to the present embodiment, since they cannot send the authentication signal S using the authentication unit 49.

As described above, in the house for the private viewing, the user given the usage permission of the key X by making the reservation can take out the key X, and privately view the house, only during the time period for which the usage permission is given.

In addition, a manager of the house can allow automatic lending of the key X to the user given the usage permission of the key X, by providing the key box 1 according to the present embodiment for the house for the viewing, and holding the house key X in the key box 1.

Further, equipment cost required for achieving the automatic lending of the key X can be reduced, since network equipment is not required to be provided in the key box 1 according to the present embodiment.

In addition, since the key X is coupled to the cord-like member 9, the key box 1 according to the present embodiment can prevent occurrence of a problem such as a problem that a user forgets to return the key X and takes it home, or loses the key X. Thus, the key box 1 according to the present embodiment can also prevent occurrence of a problem such as a problem that another user cannot borrow the key X, and cannot privately view the house.

It should be noted that the present invention is not limited only to the above-described embodiment and usage example. The dimensions and the dimensional ratios of the respective components illustrated in each figure are for convenience of illustration, and the actual dimensions and dimensional ratios are not reflected.

The key box according to the present invention may have a configuration in which the right and left of the configuration illustrated in FIG. 1 and FIG. 2 are reversed.

The arrangement of the opening operation unit 8 inside the housing 2 may be changed from the illustrated position to a direction approaching the shaft 6 of the lid 5, or to a direction away from the shaft 6. When the arrangement of the opening operation unit 8 is changed to the direction away from the shaft 6 of the lid 5, a pushing force of the lever 45 on the lid body 33 at the time of opening the lid 5 can be reduced in the key box according to the present embodiment. Thus, such configuration is advantageous when the servo motor 44 with a small output is used as the servo motor 44 of the opening operation unit 8.

On the other hand, when the arrangement of the opening operation unit 8 is changed to the direction approaching the shaft 6 of the lid 5, a length of the lever 45 and an angle of the rotation of the lever 45 that are required at the time of opening the lid 5 are reduced in the key box according to the present invention.

The opening operation unit 8 may employ a configuration other than that illustrated, as long as the opening operation unit 8 has the function to release the locking of the locking claw 40 to the locking part 41 by imparting force in a direction causing the lid 5 in the closed posture in which the opening part 4 is blocked, to rotate forward, and rotate the lid 5 forward until a gap is formed between the lid 5 and the cover 16. For example, the opening operation unit 8 may employ a configuration including a motor (servo motor) in which an arc-shaped rack having the shaft 6 as its center is attached to the lid 5, and a pinion that engages with the rack is attached inside the housing 2, or a configuration in which a part of the lid 5 is directly pushed forward with an electric actuator that is installed in a forward direction on the housing 2.

The arrangements of the signal communication section 11, the power source 12, and the controller 13 inside the housing 2 may be other than the illustrated arrangements. In addition, the arrangement of the startup switch 14 in the housing 2 may be other than the illustrated arrangement.

Although the key storage space 3 and the opening part 4 are positioned near the bottom right of the housing 2 when seen from the front in the exemplary configuration, the key storage space 3 and the opening part 4 may be disposed near the top, left, upper left, or center part of the housing 2.

The shapes of the key storage space 3 and the opening part 4 may be other than the illustrated shapes, as long as the key X desired to lend for a user, the cord-like member 9, and the key holder 10 can be stored in or taken out from the key storage space 3 through the opening part 4. In addition, the shape of the lid body 33 of the lid 5 may be appropriately changed in association with the shape of the opening part 4.

The bearing part 37 for rotatably supporting the shaft 6 of the lid 5 is provided as a notch in the bent part 26a on the left side of the partition wall 26, and in the right side of the partition wall 27 of the cover 16 in the exemplary configuration. However, the bearing part may employ a configuration other than the notch, as long as the bearing part can rotatably hold the shaft 6 of the lid 5. In addition, the bearing part 37 may be included as an independent bracket separately from the bent part 26a of the partition wall 26 and the partition wall 27.

The lid 5 may have a configuration in which a shaft is provided on the cover 16 side or the housing body 15 side, and the lid 5 is rotatably attached to this shaft, as long as the lid 5 can rotate in the front-rear direction centered on the lower end side in the closed posture in which the opening part 4 is blocked.

With regard to each of the frame parts 34, 35 and 36 provided on the rear surface 33b of the lid body 33 of the lid 5, the dimension of projection from the rear surface 33b may be appropriately changed. In addition, in order to prevent from a fall-off of the key X or the cord-like member 9 placed on the lid 5 at the time of the opened posture of the lid 5, each of the frame parts 34, 35 and 36 is preferably provided on the rear surface 33b of the lid body 33. However, any or all of the frame parts 34, 35 and 36 may be omitted. When the frame parts 35 and 36 on the right and left are omitted, the key box according to the present invention are configured such that the shaft 6 is attached to the rear surface 33b side on the lid body 33 through a bracket.

The housing 2 includes the housing body 15, the cover 16, and the lid 5 in the exemplary configuration. However, the housing 2 may have any configuration other than that illustrated, as long as the housing 2 includes the key storage space 3 therein, and is provided with the opening part 4 communicating with the key storage space 3, and the lid 5 that opens and closes the opening part 4.

In FIG. 3, FIG. 7(a), and FIG. 7(b), the housing body 15 and the cover 16 are illustrated as having outer shapes becoming gradually smaller from the front to the rear. In this regard, inclinations of the outer surfaces on the left, right, top and bottom are drafts that are desired to be provided upon manufacturing the housing body 15 and the cover 16 by molding a resin. Accordingly, needless to say, the housing 2 may have a configuration in which the outer surfaces on the left, right, top and bottom of the housing body 15 and the cover 16 are not inclined, in accordance with the materials and the manufacturing methods of the housing body 15 and the cover 16.

In addition, in the embodiment, the housing 2 has a substantially cuboid outer shape that is symmetric in the up-down direction, and is also symmetric in the left-right direction as the exemplary configuration. However, the housing 2 may have an outer shape that is asymmetric in the up-down direction, or an outer shape that is asymmetric in the left-right direction.

In the embodiment described above, both the housing body 15 and the cover 16 include the partition walls 21, 22 and 23, and the partition walls 25, 26 and 27 for partitioning the key storage space 3 inside the housing 2 in an exemplary configuration. In contrast, the partition walls for partitioning the key storage space 3 inside the housing 2 may be provided for only either of the housing body 15 and the cover 16, or the partition walls may be divided into each part so as to be provided in a distributed manner in the housing body 15 and the cover 16.

With regard to the locking claw 40 and the locking part 41 of the holding unit 7, the locking claw 40 and the locking part 41 having any shapes and structures other than those illustrated may be employed, as long as an operation of releasing the locking state is performed by applying force on the locking claw 40 and the locking part 41 in the locking state in a direction that relatively separates them, and an operation of achieving the locking state can be performed by moving the locking claw 40 and the locking part 41 in the unlocked state in a direction that relatively brings them closer so as to bring them into contact each other.

For example, the locking claw 40 may include a plate part that bends in the up-down direction, and a protrusion that is provided on any part in the up-down direction on the projected end side of the plate part. In this case, the locking part 41 receives the protrusion of the locking claw 40 from one side in the up-down direction.

In the embodiment described above, the lid 5 includes the locking claw 40, and the cover 16 includes the locking part 41 in the exemplary configuration. However, a configuration where the housing body 15 or the cover 16 includes the locking claw 40, and the lid 5 includes the locking part 41, may also be employed.

The pair of the locking claw 40 and the locking part 41 of the holding unit 7 may be disposed lower than the opening operation unit 8, or may be provided in any arrangement other than that illustrated, for example.

In addition, only one pair, or three or more pairs of the locking claw 40 and the locking part 41 of the holding unit 7 may be provided on either of the right and left sides of the opening part 4.

The signal communication section 11 may receive the authentication signal S with a method other than wireless communication, as long as the signal communication section 11 can receive the authentication signal S from the authentication unit 49. For example, the signal communication section 11 may be configured to have a function to recognize an image, and the authentication unit 49 may be configured to have a function to display the authentication signal S on a display as an image code such as a bar code or two-dimensional code. In this case, the authentication signal S can be delivered from the authentication unit 49 to the signal communication section 11 through image recognition of the image code displayed on the display of the authentication unit 49 by the signal communication section 11. Further, the signal communication section 11 may employ a communication means using light such as infrared light, or other non-contact type communication means, as long as it is a means that enables non-contact type communication in a range up to ten and several meters. In addition, when receiving the authentication signal S via wireless communication (such as BLUETOOTH (registered trademark)), the signal communication section 11 may be disposed at a position other than that illustrated.

Further, for example, the authentication unit 49 in the form of a non-contact type IC card or a contact type IC card, or in any other forms, may be used, as long as the authentication unit 49 can input the authentication signal S into the signal communication section 11.

The key X to be stored in the key box according to the present invention for automatic lending may be a key card.

In order to reduce a power consumption, the key box according to the present invention preferably employs the configuration including the startup switch 14, and has the controller 13 having the function to execute the power saving mode that stops supplying power at least to the signal communication section 11 during a time period in which the startup switch 14 is not operated. However, the function of the controller 13 to execute the power saving mode is not essential, and the controller 13 may be configured to constantly supply power to the signal communication section 11. Thus, in this case, the startup switch 14 may be omitted from the key box according to the present invention.

In addition, the key box according to the present invention may be applied to automatic lending of, for example, the key X, other than the house key X, to a storage box of a control panel for mechanical car parking apparatus, or to a room within a building such as a rental conference room, as long as the key X is such key X that is desired to be temporarily used for unlocking a constructed target object.

Needless to say, various changes may be employed without departing from the scope of the present invention.

1-4. (canceled)

5. A key box, comprising:
a housing having a key storage space therein, comprising an opening part that communicates with outside in a front side of the key storage space, a lid that blocks the opening part, and a shaft that is disposed on a lower end side of the opening part to hold the lid in a rotatable manner in a front-rear direction;
a holding unit that holds the lid in a closed posture in which the opening part is blocked;
an opening operation unit that releases the holding of the lid in the closed posture by the holding unit to open the lid;
a cord-like member that comprises one end side connected to an inside of the housing and another end side provided with a key holder which holds a key, and that couples the housing and the key holder;
a signal communication section;
a controller; and
a housing body, wherein
the controller has a function to give an opening operation command for the opening operation unit to open the lid, based on an input of an authentication signal into the signal communication section,
the lid comprises a lid body,
the lid body comprises a frame part that projects upward from a rear surface of the lid body, when the holding of the lid in the closed posture by the holding unit is released, and the opening part is opened,
the housing body comprises a stopper, and
the frame part is in contact with the stopper when the holding of the lid in the closed posture by the holding unit is released, and the opening part is opened.

6. The key box according to claim 1, wherein
the controller is connected to a power source, and
the power source is a primary battery or a secondary battery disposed inside the housing.

7. The key box according to claim 1, wherein the signal communication section receives the authentication signal via wireless communication.

8. The key box according to claim 1, wherein
the housing comprises a startup switch, and
the controller conducts a power saving mode that stops supplying power at least to the signal communication section during a time period in which the startup switch is not operated.

9. The key box according to claim 1, wherein the frame part comprises a first frame part that is disposed on a lower end side of the lid body when the lid is in the closed posture.

10. The key box according to claim 5, wherein the frame part comprises a second frame part that is disposed to extend in an up-down direction of the lid body when the lid is in the closed posture.

11. The key box according to claim 5, wherein
the housing body comprises a rear sidewall,
a curved surface is provided on a lower end side of the rear sidewall,
the first frame part moves in accordance with a rotation of the lid in a front-rear direction, and
a gap between the curved surface and the first frame part is a gap which the key does not pass through.

12. The key box according to claim 1, wherein
the housing comprises a cover,
a compartment covered with the cover is provided inside the housing,
the compartment is disposed on an upper side of the key storage space, and
the one end side of the cord-like member is connected to an inside of the compartment.

13. The key box according to claim 1, wherein
the opening operation unit comprises:
a servo motor; and
a lever that rotates by driving of the servo motor,
the opening operation unit opens the lid by rotating the lever through driving the servo motor, and then restores the lid to a position at which the lid is located before opening the lid by rotating the lever through driving the servo motor.

14. The key box according to claim 1, wherein
the signal communication section receives the authentication signal from a mobile terminal via wireless communication, and
the mobile terminal can transmit the authentication signal only in a predetermined time period.

15. The key box according to claim 5, wherein
the housing body comprises a rear sidewall,
a curved surface is provided on a lower end side of the rear sidewall,
the first frame part moves in accordance with a rotation of the lid in a front-rear direction, and
the stopper is disposed on the upper side of the curved surface to project to a front.

16. The key box according to claim 11, wherein the first frame part is in contact with an undersurface of the stopper, when the holding of the lid in the closed posture by the holding unit is released and the opening part is opened.
